(19) United States
(12) Patent Application Publication
(10) Pub. No.: US 2021/0292463 A1
(43) Pub. Date: Sep. 23, 2021

(54) DYNAMIC POLYURETHANE NETWORKS WITH POST-RECYCLING RETENTION OF CROSS-LINKING DENSITIES AND MECHANICAL PROPERTIES

(71) Applicant: Northwestern University, Evanston, IL (US)

(72) Inventors: John M. Torkelson, Skokie, IL (US); Xi Chen, Evanston, IL (US); Sumeng Hu, Evanston, IL (US); Lingqiao Li, Houston, TX (US)

(21) Appl. No.: 17/205,206

(22) Filed: Mar. 18, 2021

Related U.S. Application Data
(60) Provisional application No. 62/991,148, filed on Mar. 18, 2020.

(51) Int. Cl. C08G 18/10; C08G 18/32; C08G 18/48; C08G 18/20; C08G 18/76; C08J 11/24

(52) U.S. Cl. CPC C08G 18/10; C08G 18/3206; C08G 18/4845; C08J 2375/08; C08G 18/7621; C08J 11/24; C08G 18/2018

(57) ABSTRACT

Reprocessable crosslinked polyurethane networks, methods for making the reprocessable polyurethane networks, and methods for depolymerizing the crosslinked polyurethane networks and recovering the depolymerized monomers are provided. The polyurethane networks are rendered reprocessable by the incorporation of free hydroxyl groups and the incorporation of multi-functional alcohol crosslinkers.

### CROSS-REFERENCE TO RELATED APPLICATIONS

The present application claims priority to U.S. provisional patent application No. 62/991,148 that was filed Mar. 18, 2020, the entire contents of which are incorporated herein by reference.

### BACKGROUND

Cross-linked polymers are used in many high-value applications owing to their outstanding stability and performance. However, permanent covalent bonds in traditional cross-linked polymers prevent them from being reprocessed in the melt state, leading to major sustainability and economic losses. To address this problem, research has been dedicated to incorporating dynamic covalent bonds into polymer networks, which enable the rearrangement of network chains under proper stimulus, thus allowing for reprocessing or recycling of these cross-linked polymers. The dynamic chemistries are commonly classified into two types: (1) dissociative dynamic chemistries based on dissociative reversible reactions, including Diels-Alder addition and alkoxyamine chemistry; (2) associative exchange chemistries based on associative exchange reactions, including transesterification, transamination, and dioxaborolane metathesis. In some cases, the dynamic chemistry involves both dissociative and associative mechanisms, e.g., hydroxyurethane and thiourethane dynamic chemistries.

Polyurethanes (PUs) are among the most widely used polymers worldwide. The applications of PUs include elastomers, adhesives, coatings, and foams, and commonly involve cross-linked architectures. To address the recycling issue associated with PU thermosets reaching their end of life, previous studies have adopted different extrinsic dynamic chemistries to achieve reprocessability in cross-linked PU or PU-like materials. In some studies, PU networks are synthesized from the traditional isocyanate-alcohol reaction, with additional dynamic functional groups incorporated during synthesis, e.g., hindered urea bonds, reversible C—C bonds and disulfide bonds. (Zhang, Y. et al., Adv. Mater. 2016, 28, 7646-7651; Chen, L. et al., Macromol. Chem. Phys. 2020, 221, 1900440; Zhang, Z. P. et al., Adv. Funct. Mater. 2018, 28, 1706050; Chen, J.-H. et al., Polymer 2018, 143, 79-86; and Gao, W. et al., Polymer 2018, 151, 27-33.) In other studies, reprocessable PU-like materials are synthesized with the formation of dynamic covalent bonds that are structurally similar to urethanes groups, e.g., hydroxyurethane bonds, thiourethane bonds, and oxime-carbamate bonds. (Chen, X. et al., Polym. Chem. 2017, 8, 6349-6355; Fortman, D. J. et al., J. Am. Chem. Soc. 2015, 137, 14019-14022; Li, L. et al., Macromolecules 2019, 52, 8207-8216; Liu, W.-X. et al., J. Am. Chem. Soc. 2017, 139, 8678-8684; and Fu, D. et al., J. Mater. Chem. A 2018, 6, 18154-18164.) However, these synthetic strategies lead to changes in molecular structure and sometimes bulk properties of cross-linked PUs, and some strategies involve complicated monomer synthesis.

Stress relaxation of PU networks at elevated temperatures was first reported by Tobolsky and co-workers in 1956 and was attributed to the dissociation of urethane linkages to isocyanates and alcohols. (Offenbach, J. A. et al., J. Colloid Sci. 1956, 11, 39-47; and Colodny, P. C. et al., J. Am. Chem. Soc. 1957, 79, 4320-4323.) Recently, the dynamic nature of urethane bonds has been exploited to achieve advanced characteristics in PU networks, including self-healing, plasticity, and reprocessability. For example, Lei and co-workers reported that multifunctional PU-vitrimers synthesized from renewable castor oil can be reprocessed at 180° C. in 2 h with the presence of dibutyltin dilaurate (DBTDL) catalyst. (Yan, P. et al., RSC Adv. 2017, 7, 26858-26866.) Dichtel and co-workers investigated the use of several Lewis acid catalysts in cross-linked PU networks to achieve reprocessability under mild conditions. (Fortman, D. J. et al., Macromolecules 2019, 52, 6330-6335.) The use of phenol-carbamate bonds has also been explored, which involves non-traditional synthesis of PU networks from phenols. (Shi, J. et al., Polymer 2019, 181, 121788; and Shi, J. et al., ACS Sustainable Chem. Eng. 2020, 8, 1207-1218.) Despite these efforts attempting to develop PU networks with intrinsic reprocessability, no study has reported full recovery of cross-link density and tensile properties after reprocessing.

### SUMMARY

Crosslinked polyurethane networks, methods for making the crosslinked polyurethane networks, and methods for depolymerizing the crosslinked polyurethane networks are provided.

One embodiment of a crosslinked polyurethane network includes: the reaction product of a poly(alkylene glycol) diisocyanate monomer and polyol having at least three hydroxyl groups; and an alcoholysis catalyst; wherein the crosslinked polyurethane network has a free hydroxyl group concentration of at least 4 mol. %.

One embodiment of a method for recovering monomers from a crosslinked polyurethane network comprising: (a) the reaction product of a poly(alkylene glycol) diisocyanate monomer and a polyol crosslinker having at least three hydroxyl groups; and (b) an alcoholysis catalyst; wherein the crosslinked polyurethane network has a free hydroxyl group concentration of at least 4 mol. %, includes the steps of: heating the crosslinked polyurethane network in the presence of an alcohol solvent to a temperature in the range from 100° C. to 150° C. to depolymerize the poly(alkylene glycol) diisocyanate monomers and polyol crosslinker; and recovering the poly(propylene glycol) diisocyanate monomers.

One embodiment of a method of forming a reprocessable crosslinked polyurethane network includes the steps of: reacting a poly(alkylene glycol) diisocyanate with a multi-functional alcohol crosslinker having at least three hydroxyl groups in the presence of an alcoholysis catalyst to form a crosslinked polyurethane network, wherein the multi-functional alcohol crosslinker is present in sufficiently high excess to provide the crosslinked polyurethane network with a free hydroxyl group concentration of at least 4 mol. %.

### BRIEF DESCRIPTION OF THE DRAWINGS

Illustrative embodiments of the invention will hereafter be described with reference to the accompanying drawings, wherein like numerals denote like elements.

FIG. 1 shows a mechanism of synthesis and rearrangement of PU networks.

FIGS. 2A-2D show dynamic mechanical responses of DMAP-containing (FIG. 2A) Triol-0OH, (FIG. 2B) Triol-20OH, (FIG. 2C) Tetraol-0OH, and (FIG. 2D) Tetraol-20OH networks: E′ and tan δ (E″/E′) as functions of temperature for as-synthesized, 1st molded, and 2nd molded samples. Inset: zoomed-in rubbery plateau moduli as a function of temperature.

FIG. 3 shows high-temperature dynamic mechanical responses of as-synthesized PU networks containing DMAP: E′ as a function of temperature. Inset: zoomed-in E′ results with T_{flow} labeled for each sample.

FIG. 4A shows E′ and tan δ (E″/E′) as functions of temperature for as-synthesized, 1st molded, and 2nd molded Tetraol-20OH-Tin samples. Inset: zoomed-in rubbery plateau moduli as a function of temperature. FIG. 4B shows the high-temperature dynamic mechanical response of the as-synthesized Tetraol-20OH-Tin network: E′ as a function of temperature. (“Tin” refers to the DBTDL catalyst.)

FIG. 5 shows the depolymerization of a polyurethane network in the presence of a polyol.

### DETAILED DESCRIPTION

Reprocessable crosslinked polyurethane networks, methods for making the reprocessable crosslinked polyurethane networks, and methods for depolymerizing the crosslinked polyurethane networks and recovering the depolymerized monomers are provided.

The polyurethane networks are rendered reprocessable (recyclable) by dynamic urethane chemistry, which involves both associative and dissociative mechanisms, as illustrated in the Example below. This dynamic urethane chemistry enables the polyurethane networks to retain their mechanical properties and thermal stabilities after one or more high temperature reprocessing cycles. The dynamic urethane chemistry is facilitated by incorporating excess free hydroxyl groups into the polyurethane network and/or by utilizing multi-functional alcohol crosslinkers having at least four reactive hydroxyl functionalities, including multi-functional alcohol crosslinkers having five or more reactive hydroxyl functionalities.

In the dynamic polyurethane networks, the free hydroxyl groups suppress the reversion of urethane links and minimize side reactions associated with liberated isocyanate groups under reprocessing conditions, while tetra- and higher functional crosslinkers help to maintain network integrity in the presence of small levels of side reactions.

The crosslinked polyurethane networks are synthesized by reacting polyisocyanates with multi-functional alcohols to form a network of polymer chains connected via urethane linkages. As used herein, the term “polyisocyanate” refers to an isocyanate having at least two isocyanate functionalities. Diisocyanates are polyisocyanates having two isocyanate functionalities. As used herein, the term “multi-functional alcohol” refers to an alcohol having at least three hydroxyl (—OH) functionalities available to form crosslinks in the polyurethane network. Thus, multi-functional alcohols are polyols with three or more reactive —OH groups. Examples of multi-functional alcohols include tri-functional alcohols (“triols”), such as trimethylpropane and tetra-functional alcohols (“tetraols”), such as pentaerythritol. Some embodiments of the crosslinked polyurethane networks are synthesized by reacting polyisocyanates, such as diisocyanates with diols. Thus, it should be understood that the various embodiments of the crosslinked polyurethane networks described herein that are synthesized by reacting polyisocyanates with multi-functional alcohols, could alternatively be formed by reacting polyisocyanates having at least three isocyanate functionalities with diols.

The synthesis is carried out in solution in the presence of a catalyst that is catalytically active for alcoholysis at an elevated temperature. A variety of organic solvents can be used, provided the reactants are substantially soluble therein and that the solvents have boiling point temperatures above the synthesis temperature. The catalyst is present as a minor component. As used herein, the term elevated temperature refers to temperatures above room temperature (e.g., above about 23° C.). Suitable temperature will depend on the selected reactants and catalyst; however, temperatures of 60° C. and greater (e.g., temperatures in the range from 60° C. to 150° C.) are typically suitable. 4-(dimethylamino)pyridine (DMAP) is one example of a alcoholysis catalyst that can be used. Other organic base catalysts can be used. These include triphenylphosphine, triazabicyclodecene (TBD), and 1,8-diazabicyclo(5.4.0)undec-7-ene (DBU). The concentration of catalyst in the polyurethane network may be in the range from about 0.5 wt. % to about 5 wt. %. However, concentrations outside of these ranges can be used.

During the synthesis of the polyurethane networks, the multi-functional alcohols (or the diols) are present in excess (i.e., at a super-stoichiometric concentration). As a result, when the multi-functional alcohols (or the diols) react with the polyisocyantes, some, but not all, of the hydroxyl groups react with the polyisocyantes to form urethane bonds. The remaining unreacted hydroxyl groups (i.e., those that are not incorporated into the urethane bonds) are referred to herein as “free hydroxyl groups.” (For the purposes of this disclosure, once the multi-functional alcohols (or diols) are incorporated into the polyurethane network via reaction with the polyisocyantes, they are referred to as multi-functional alcohol-based (or diol-based) crosslinking groups.) In some embodiments, the polyurethane networks are polymerized from only the polyisocyanate monomers and the multi-functional alcohol (or diol) crosslinkers. In some embodiments, the polyurethane networks are polymerized from diisocyanate monomers and multi-functional alcohol crosslinkers. In some embodiments, the polyurethane networks are polymerized from only diisocyanate monomers and multi-functional alcohol crosslinkers.

When the free alcohol groups are present at a sufficiently high concentration, the resulting crosslinked polyurethane network is able to undergo reprocessing at elevated temperatures with little or no loss of mechanical or thermal properties. The desired concentration of free hydroxyl groups that are introduced into the crosslinked polyurethane network will depend on the desired level of reprocessability required for a given application. By way of illustration, some embodiments of the crosslinked polyurethane networks have a free hydroxyl group concentration of at least 4 mol. %. This includes embodiments of the crosslinked polyurethane networks having a free hydroxyl group concentration of at least 10 mol. %, at least 20 mol. %, and at least 30 mol. %. For example, various embodiments of crosslinked polyurethane networks have a free hydroxyl group concentration in the range from 4 mol. % to 40 mol. %.

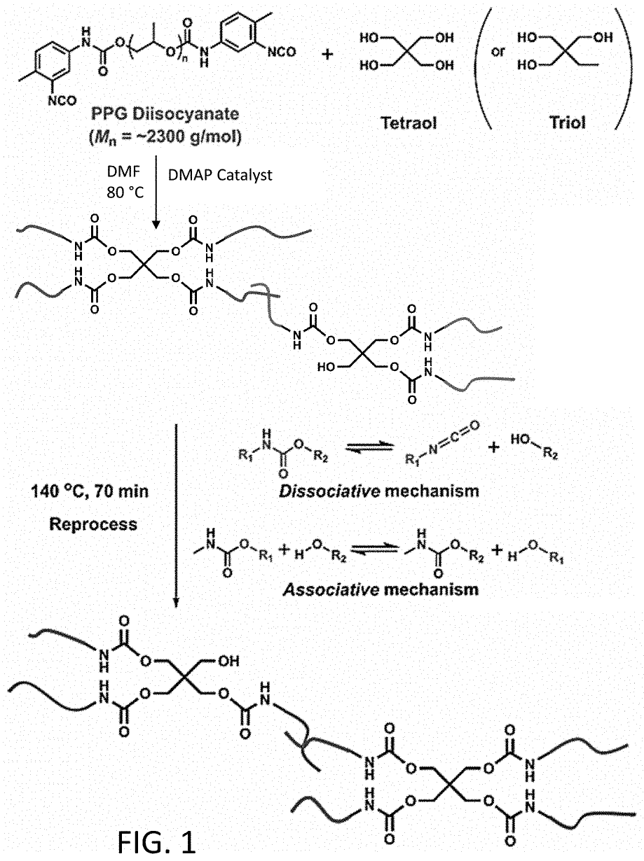

Various types of polyiisocyanates can be used in the synthesis of the polyurethanes. Poly(alkylene glycol) diisocyanates, including poly(propylene glycol) (PPG) diisocyanates and poly(ethylene glycol) (PEG) diisocyanates are examples. The PPG diisocyanates are characterized by repeating ether units in their backbone chain and two isocyanate groups, which are typically at the chain ends. The structure of a PPG diisocyanate is illustrated in the upper left panel of FIG. 1, where n represents the number of repeat units in the polymer chain. The value of n can be chosen to provide a polyurethane with the desired properties for a given application. By way of illustration, in some embodiments of the methods of synthesizing the polyurethane networks, the PPG diisocyanate has an n value in the range from 1 to 400 and/or number average molecular weights in the range from 2000 to 3000 g/mol. Other diisocyanates that can be used include poly(tetramethylene glycol) diisocyanate, tolylene-2,4-diisocyanate (TDI), methylenediphenyl diisocyanate (MDI), hexamethylene diisocyanate, isophorone diisocyanate, methylene bis(4-cyclohexyisocyanate).

The reprocessability of the polyurethane networks is reflected by their ability to recover their crosslinking density and mechanical properties after undergoing one or more reprocessing cycles. As a standard test for reprocessability, the crosslinked polyurethane networks can be heated to 140° C., sustained at that temperature for 70 minutes, and then allowed to cool to room temperature (23° C.), as described in the Example.

The crosslinking density of a polyurethane network can be determined by measuring the polyurethane network's rubbery plateau modulus (E′). However, other mechanical properties that may be recovered after one or more reprocessing cycles include the network's Young's modulus, tensile strength, and/or strain at break. Appropriate methods for measuring each of these properties are described in the Example. As illustrated in the Example, any one of, or all of, these mechanical properties may be recovered to a level of at least 75%, at least 80%, at least 85%, at least 90%, at least 95%, or even 100% after the polyurethane network undergoes one or more reprocessing cycles at 140° C. for 70 min.

In addition, the crosslinked polyurethane networks may be characterized by enhanced thermal stabilities, as reflected in an increase in the temperature at which the crosslinked polyurethane network flows like a liquid (T_{flow}), relative to the T_{flow} that the crosslinked polyurethane network would have without the free hydroxyl groups. By way of illustration, in some embodiments of the crosslinked polyurethane networks, the T_{flow} is increased by at least 20%, at least 30%, or at least 40% (e.g., 20% to 50%) by the presence of the free hydroxyl groups in the network. This increase may correspond to T_{flow} temperatures of, for example, at least 250° C., at least 260° C., and at least 270° C. (e.g., 250° C. to 280° C.).

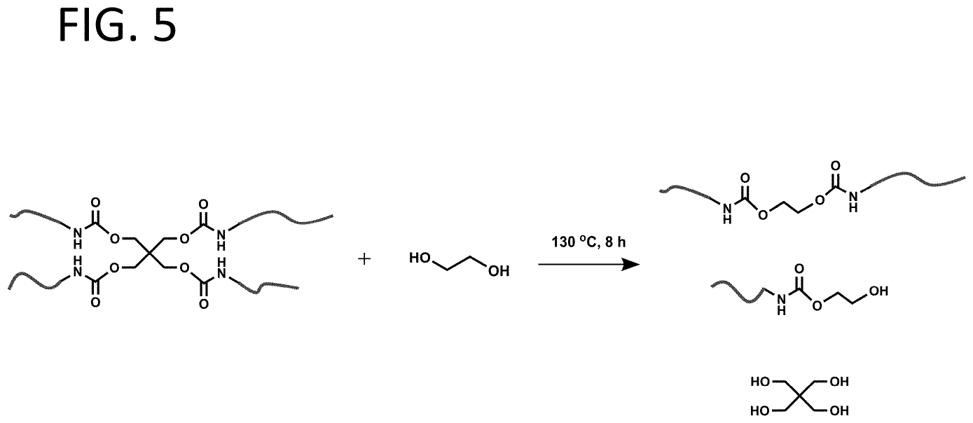

Another aspect of the crosslinked polyurethanes described herein is their ability to be depolymerized into monomers that can then be separated from the depolymerization solution, recovered, and reused. The solvent used for the depolymerization should include one or more alcohol groups (e.g., polyols) that participate in the depolymerization, as illustrated in FIG. 5. The depolymerization can be carried out in solution via alcoholysis by heating a solution of the crosslinked polyurethane network in the presence of a catalyst that is catalytically active for alcoholysis for a time sufficient to allow for the desired degree of depolymerization. This can be accomplished at mild temperatures, such as temperatures of 150° C. or lower, including temperatures of 130° C. or lower, and over relatively short time periods, such as time periods of 12 hours or less. For example, temperatures in the range from 110° C. to 150° C. can be used. DMAP is one example of a suitable catalyst. Depending upon the catalyst concentration in the original polyurethane network and the depolymerization temperature and timeframe, the depolymerization may be carried out without the need to add more of the catalyst. However, in order to facilitate the depolymerization and/or increase the rate of depolymerization, it may be desirable to add more of the catalyst.

One the polyurethane networks have been depolymerized, the polyisocyanate monomers and/or the multi-functional alcohol (or diol) crosslinkers can be recovered by separating them from the solution. The recovered monomers can then be recycled and reused in the synthesis of other polymers.

Potential applications of the polyurethane networks described herein include use as recyclable polyurethane network elastomers, self-healable polyurethane coatings, recyclable polyurethane foams, and depolymerizable and repolymerizable polyurethane thermosets. Advantages of the methods used to make the crosslinked polyurethane networks include the use of simple chemistry from readily available materials, excellent property recovery after recycling, enhanced thermal stability of the polyurethanes, and the potential for monomer recovery under mild reaction conditions.

### Example

This example illustrates a PU network that exhibits full property recovery after multiple reprocessing steps and further illustrates the ability of the PU network to undergo alcoholysis, thereby allowing for the recovery of alcohol monomers under relatively mild conditions.

As shown in FIG. 1, PU networks were synthesized from a poly(propylene-glycol)-based diisocyanate (PPG Diisocyanate) and a trifunctional alcohol trimethylolpropane (Triol) or a tetrafunctional alcohol pentaerythritol (Tetraol). For each type of cross-linker, the reaction was performed both at stoichiometric balance (0OH) and with 20 mol % hydroxyl group in excess (20OH). Urethane dynamic chemistry involves both associative and dissociative mechanisms. When excess free hydroxyl groups are present, associative transcarbamoylation exchange reactions could occur between carbamate groups and hydroxyl groups. As well, urethane linkages could dissociate, thereby forming alcohols and isocyanates at elevated temperature. Here, it was considered that this dual-mechanism nature exists in both OOH and 20OH samples because the reversion of urethane bonds releases free hydroxyl groups that can participate in the associative pathway (FIG. 1).

All PU networks were synthesized with 20 mol % 4-(dimethylamino)pyridine (DMAP) catalyst with respect to isocyanate functional groups, which accounts for ˜2 wt % of the total material. As-synthesized samples were obtained by curing the reactant mixture (some minutes at 60° C. and then overnight at 80° C.) in an aluminum pan, followed by 48-h vacuum drying at 80° C. to remove solvent. The isocyanate peak at 2270 cm⁻¹ observed in the Fourier-transform infrared (FTIR) spectrum of PPG Diisocyanate disappeared in all as-synthesized PU networks, indicating complete conversion within error of isocyanate groups. The as-synthesized materials were reprocessed for two cycles at 140° C. for 70 min using compression molding. The same reprocessing condition was applied for all samples to ensure fair comparison of reprocessability and resulting properties. In all cases, consolidated and homogeneous films were obtained after reprocessing, indicating effective network rearrangement enabled by the dynamic chemistry.

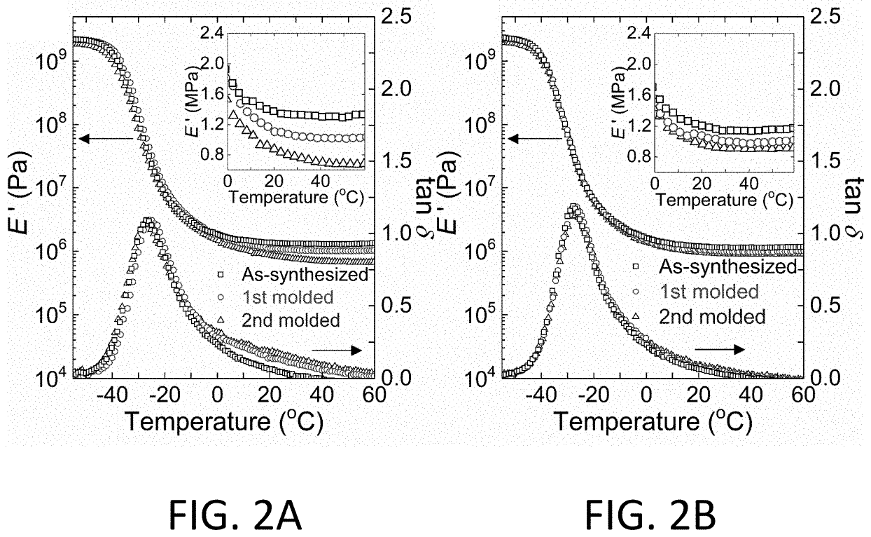

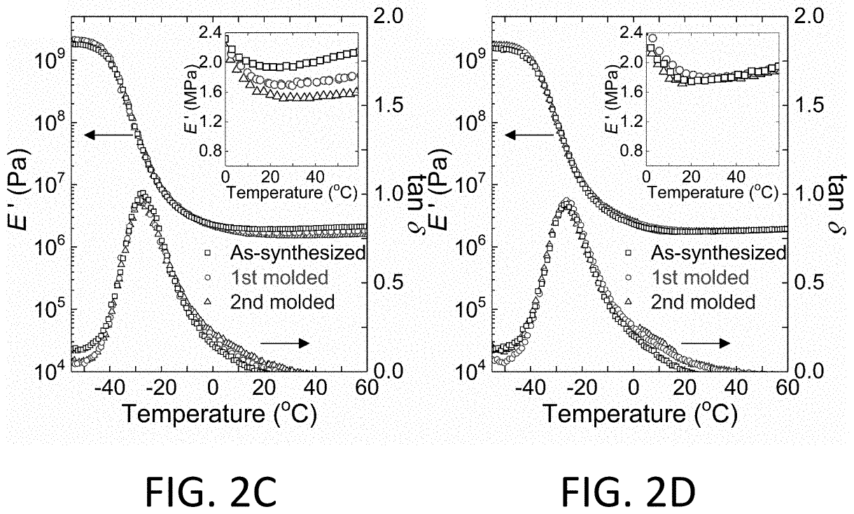

FIG. 2A shows the dynamic mechanical analysis (DMA) results of as-synthesized, 1st molded and 2nd molded Triol-0OH networks. In all three samples, a rubbery plateau in the storage tensile modulus E′ was observed at temperatures well above the glass transition temperature (T_{g}), confirming their cross-linked nature. The E′ rubbery plateau moduli determined at 40° C. are summarized in Table 1, which indicate a 76% recovery in the 1st molding step (relative to the as-synthesized material) and a 67% recovery in the 2nd molding step (relative to the 1st molded sample). According to ideal rubbery elasticity theory, the rubbery plateau modulus is proportional to cross-link density. This incomplete cross-link density recovery after reprocessing is likely due to side reactions associated with isocyanate groups at elevated temperatures. During the molding process at 140° C., highly reactive free isocyanate groups were generated from the dissociative reaction of urethanes. These liberated isocyanate groups may then undergo undesired side reactions in the presence of moisture (in air and absorbed by the network) at high temperature, leading to property losses in molded Triol-0OH networks.

TABLE 1
Rubbery-plateau tensile storage moduli and room-temperature tensile properties of
as-synthesized and molded PU networks.

| | | E′ at | Young's | Tensile | Strain |
|---|---|---|---|---|---|
| | | 40° C. | Modulus | strength | at break |
| Sample | | (MPa) | (MPa) | (MPa) | (%) |
| Triol- | As-synthesized | 1.30 ± 0.04 | 1.46 ± 0.04 | 1.12 ± 0.03 | 349 ± 12 |
| 0OH | 1st molded | 0.99 ± 0.05 | 1.19 ± 0.03 | 0.67 ± 0.10 | 212 ± 52 |
| | 2nd molded | 0.66 ± 0.04 | 0.92 ± 0.10 | 0.57 ± 0.04 | 243 ± 36 |
| Triol- | As-synthesized | 1.13 ± 0.04 | 1.20 ± 0.03 | 1.05 ± 0.03 | 464 ± 43 |
| 20OH | 1st molded | 0.97 ± 0.03 | 1.19 ± 0.02 | 0.85 ± 0.03 | 344 ± 45 |
| | 2nd molded | 0.90 ± 0.07 | 0.99 ± 0.03 | 0.81 ± 0.08 | 326 ± 45 |
| Tetraol- | As-synthesized | 2.00 ± 0.04 | 2.35 ± 0.07 | 1.35 ± 0.11 | 195 ± 14 |
| 0OH | 1st molded | 1.72 ± 0.01 | 2.37 ± 0.09 | 1.17 ± 0.04 | 162 ± 21 |
| | 2nd molded | 1.53 ± 0.05 | 2.13 ± 0.03 | 1.01 ± 0.07 | 138 ± 21 |
| Tetraol- | As-synthesized | 1.79 ± 0.03 | 1.90 ± 0.03 | 1.16 ± 0.07 | 200 ± 19 |
| 20OH | 1st molded | 1.76 ± 0.05 | 2.01 ± 0.10 | 1.19 ± 0.17 | 152 ± 20 |
| | 2nd molded | 1.71 ± 0.06 | 1.99 ± 0.12 | 1.11 ± 0.07 | 157 ± 27 |
| Tetraol- | As-synthesized | 2.16 ± 0.05 | 2.23 ± 0.01 | 1.68 ± 0.04 | 228 ± 8 |
| 20OH- | 1st molded | 0.96 ± 0.02 | 0.94 ± 0.00 | 0.64 ± 0.04 | 212 ± 20 |
| Tin | 2nd molded | 0.50 ± 0.01 | 0.40 ± 0.03 | 0.33 ± 0.02 | 249 ± 22 |

To suppress side reactions of isocyanate groups during reprocessing, 20 mol % free hydroxyl groups were incorporated in the PU network by running the reaction slightly off-stoichiometry. The DMA results of as-synthesized and molded Triol-20OH networks are shown in FIG. 2B. Compared with the Triol-0OH network, the as-synthesized Triol-20OH network had a slightly decreased E′ rubbery plateau modulus because of the unbalanced stoichiometry. However, much better recovery of E′ rubbery plateau modulus and thus cross-link density (86% in the 1st molding (relative to as-synthesized) and 93% in the 2nd molding (relative to the 1st molding)) was obtained in molded Triol-20OH networks; see Table 1. The presence of free hydroxyl groups during reprocessing had two effects. First, hydroxyl groups reduced side reactions by reacting promptly with free isocyanate groups released in the dissociative reaction and pushing the reaction equilibrium toward urethane moieties. Second, hydroxyl groups promoted the associative mechanism relative to the dissociative mechanism of urethane bonds and thereby reduce the level of side reactions. Thus, adding free hydroxyl groups is an effective way to enhance cross-link density and property recovery of PU networks after reprocessing.

Polyurethane networks were also synthesized using a tetrafunctional alcohol Tetraol as the cross-linker. FIG. 2C shows DMA results of Tetraol-0OH samples synthesized at stoichiometric balance. By increasing the cross-linker functionality from three to four, the E′ rubbery plateau modulus (at 40° C.) of the resulting as-synthesized PU network increased from 1.30 MPa to 2.00 MPa (Table 1). More importantly, as evidenced by E′ plateau values, the property recovery of recycled Tetraol-0OH networks improved compared with recycled Triol-0OH networks. The use of Tetraol cross-linker is beneficial for property recovery in two ways. First, compared to networks formed with trifunctional cross-linker, at the reprocessing condition, networks formed with tetrafunctional cross-linker had a higher fraction of chains that remained cross-linked and a lower fraction of free-moving linear chains generated from the dissociative reaction. As a result, the networks had more restricted mobility, and isocyanate groups were less exposed to conditions that may have induced side reactions. Second, the network structure formed with tetrafunctional cross-linker had more tolerance towards side reactions. Even if one of the four branches at the junction point could not be recovered due to the loss of isocyanate functionality during reprocessing, the remaining three branches still afforded a cross-linked structure, and the resulting network did not exhibit significant reduction in properties associated with cross-link density. In contrast, if the network formed with trifunctional cross-linker lost one branch at the junction point, the cross-linked structure became a (locally) linear structure, leading to substantial property losses. Thus, the property recovery of recycled PU networks can also be improved by replacing trifunctional cross-linker with tetrafunctional cross-linker.

A Tetraol-20OH PU network was then prepared, which was formed using the tetrafunctional cross-linker and contained 20 mol % free hydroxyl groups in excess. As shown in FIG. 2D and Table 1, within error, the Tetraol-20OH network exhibited full recovery of the rubbery plateau E′ value after multiple reprocessing steps. This very positive outcome was in contrast with outcomes obtained in the other three PU networks and indicates that replacing the trifunctional cross-linker with a tetrafunctional cross-linker and adding a small amount of excess free hydroxyl groups can lead to full property and cross-link density recovery in reprocessable PU networks.

Notably, no apparent changes were observed in FTIR spectra and T_{g} values (from the peak of E″ curves) of all four PU networks after reprocessing. Despite evident reductions observed in E′ plateau moduli of recycled Triol-0OH, Triol-20OH, and Tetraol-0OH samples, changes in molecular structures of these samples may have been insufficient to cause differences in FTIR spectra and T_{g}s.

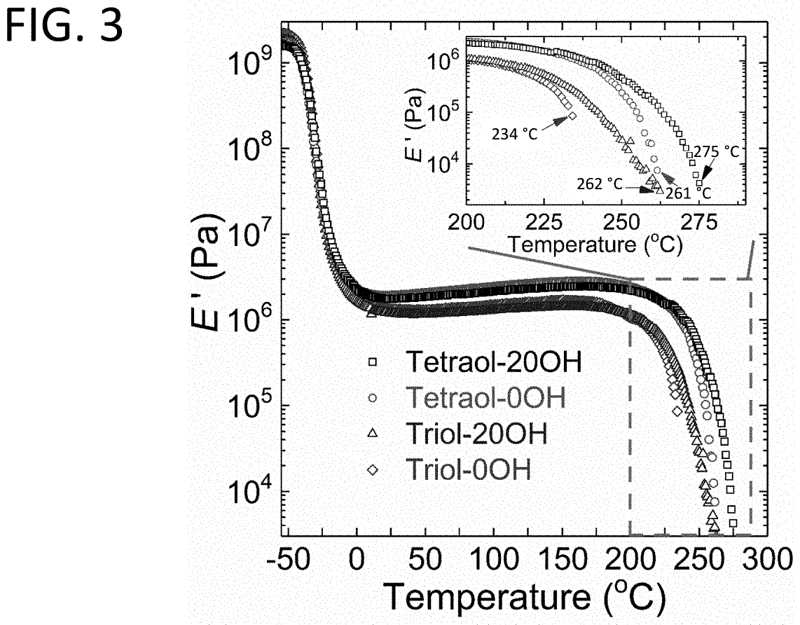

High-temperature DMA was also performed on the as-synthesized PU network samples; see FIG. 3. At temperatures between 25° C. and 150° C., rubbery plateaus were observed in all samples. With increasing temperature above 150° C., E′ values started to decrease gradually, indicating losses in the total number of cross-links. At sufficiently high temperature, the rate of dynamic chemistries became more rapid, and the cross-link density change resulting from the dissociative reaction starts to manifest in the sample moduli. As temperature is further increased, the material loses mechanical integrity and flows like a liquid, with the DMA equipment reporting inconsistent E′ values. Measurements were stopped at this point, and the corresponding temperature recorded as Mow.

Compared with the Triol-0OH sample, which had T_{flow}=234° C., the T_{flow}s of Triol-20OH and Tetraol-0OH were enhanced by ˜28° C., and the T_{flow} of Tetraol-20OH was enhanced by 41° C. These results indicate that the thermal stability of PU networks can be enhanced by incorporating excess free hydroxyl groups in the network and/or by replacing Triol with Tetraol. In the presence of free hydroxyl groups, the reversion of urethane is suppressed, and more chains remain in the cross-linked network at elevated temperatures. With Tetraol replacing Triol, the network can withstand the loss of more chains in the dissociative reaction while maintaining a cross-linked nature, thereby remaining mechanically robust to somewhat higher temperature. These thermal stability results are in good agreement with the property recovery results.

In addition to DMA measurements, tensile and swelling tests were used to evaluate the recovery of mechanical properties and cross-link density in PU networks. Table 1 gives Young's modulus, tensile strength, and strain at break results of as-synthesized and molded PU networks. Among the four networks, Tetraol-20OH showed the best property recovery after reprocessing, with the 2nd molded sample fully recovering all properties within experimental error. In accordance with DMA results, both Tetraol-0OH and Triol-20OH networks exhibited moderate recovery of Young's modulus and tensile strength after reprocessing, and the Triol-0OH network exhibited the worst property recovery. Because the tensile tests were performed at room temperature, which is substantially higher than T_{g}s of all PU networks, these mechanical property results describe elastomeric responses that are related to cross-links. Table 2 shows swelling ratio and gel fraction results of as-synthesized and molded PU networks. Due to its highest susceptibility to side reactions, Triol-0OH was the only network that exhibited an increase in swelling ratio and a decrease in gel content after reprocessing, consistent with a significant loss in cross-links. In spite of the stoichiometric imbalance in synthesis, the Tetraol-20OH network was in a highly cross-linked state (gel fraction 99%), which was maintained after each molding cycle. In all, with the incorporation of excess hydroxyl groups and the substitution of the trifunctional cross-linker by the tetrafunctional cross-linker, fully reprocessable PU networks were obtained with excellent recovery of cross-link density and tensile properties after multiple molding cycles.

TABLE 2
Gel content and swelling ratio of
as-synthesized and molded PU networks.

| | | Swelling | Gel |
|---|---|---|---|
| | | Ratio | Content |
| Sample | | (%) | (%) |
| Triol- | As-synthesized | 731 ± 16 | 97.0 ± 0.2 |
| 0OH | 1st molded | 760 ± 41 | 93.7 ± 0.7 |
| | 2nd molded | 879 ± 18 | 90.4 ± 1.3 |
| Triol- | As-synthesized | 710 ± 9 | 96.8 ± 1.0 |
| 20OH | 1st molded | 663 ± 43 | 95.9 ± 0.3 |
| | 2nd molded | 688 ± 30 | 95.5 ± 2.3 |
| Tetraol- | As-synthesized | 483 ± 25 | 99.3 ± 0.7 |
| 0OH | 1st molded | 483 ± 25 | 98.8 ± 0.2 |
| | 2nd molded | 498 ± 8 | 98.3 ± 0.6 |
| Tetraol- | As-synthesized | 481 ± 60 | 99.1 ± 0.4 |
| 20OH | 1st molded | 481 ± 19 | 99.2 ± 0.4 |
| | 2nd molded | 505 ± 14 | 98.8 ± 0.9 |
| Tetraol- | As-synthesized | 430 ± 5 | 97.4 ± 0.8 |
| 20OH- | 1st molded | 585 ± 8 | 88.4 ± 2.8 |
| Tin | 2nd molded | 798 ± 40 | 78.3 ± 7.8 |

In previous studies on reprocessable PU networks, DBTDL catalyst was commonly used to achieve the dynamic characteristic of urethane linkages. (Yan, P. et al., RSC Adv. 2017, 7, 26858-26866; Fortman, D. J. et al., Macromolecules 2019, 52, 6330-6335; Liu, W. et al., Macromolecules 2019, 52, 6474-6484; and Wang, Y. et al., Macromol. Rapid Commun. 2019, 40, 1900001.) The use of this catalyst was explored in the best-performing PU network, and a Tetraol-20OH-Tin network was synthesized containing 1 mol % DBTDL with respect to isocyanate groups. The same condition (140° C., 70 min) was applied to reprocess this Tetraol-20OH-Tin network. However, the sample became very sticky and was hardly able to be removed from the Kapton film without breaking, suggesting a significant extent of decross-linking during reprocessing. Thus, a milder condition (120° C., 15 min) was used to obtain intact molded films.

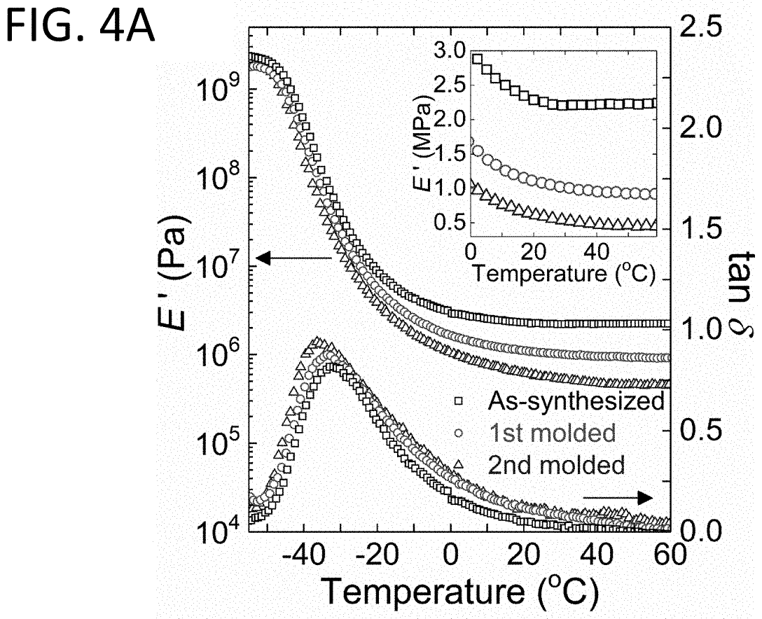

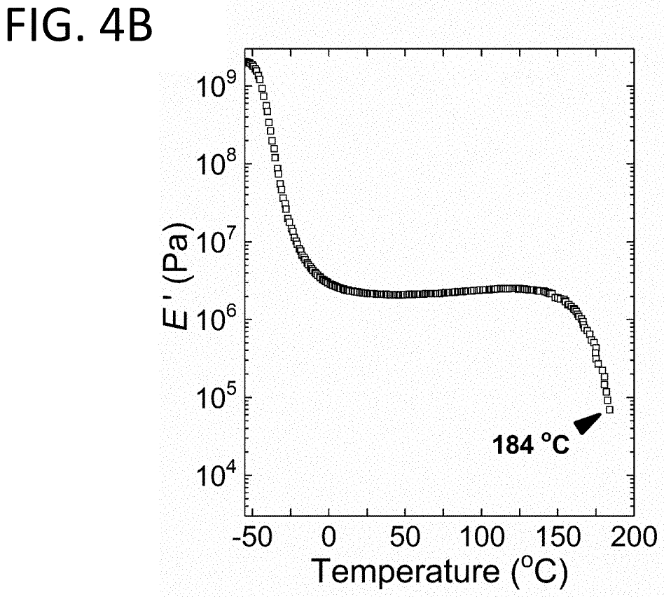

The Tetraol-20OH-Tin network showed poor recovery of properties after reprocessing, which was evidenced by major reductions in rubbery plateau E′ values (FIG. 4A and Table 1), the shifting of tan δ and E″ peaks towards lower temperatures, the loss in tensile properties (Table 1), and the increase in swelling ratio as well as decrease in gel fraction (Table 2). In addition, compared with the Tetraol-20OH network, T_{flow} of the as-synthesized Tetraol-20OH-Tin network decreased by 91° C. (FIG. 4B). The poor thermal stability and property retention were possibly due to the overly strong catalytic activity of DBTDL for the urethane dynamic chemistry, leading to a significant level of side reactions and loss of urethane cross-links during reprocessing. The FTIR spectra of Tetraol-20OH-Tin networks revealed obvious decreases in characteristic peaks of urethane linkages after reprocessing, including the C═O stretching band at 1728 cm⁻¹, the amide II combination band at 1533 cm⁻¹, and the amide III combination band at 1225 cm⁻¹. The significant difference between property recovery efficiencies of Tetraol-20OH and Tetraol-20OH-Tin networks suggests the importance of catalyst selection in forming dynamic PU networks with good reprocessability.

Apart from reprocessability, via a proof-of-principle demonstration showed that the dynamic nature of urethane bonds can also be used to decross-link or depolymerize the network, which could lead to recovery of alcohol monomers. 300 mg of as-synthesized Tetraol-20OH was mixed with 0.5 eq DMAP (with respect to urethane linkages) and 1 mL ethylene glycol and the mixture was heated at 130° C. for 8 h. A phase-separated liquid mixture was obtained after heating, which could be completely dissolved in tetrahydrofuran. The decross-linking was a result of alcohols participating in dynamic chemistries at elevated temperature. Compared with previous studies on alcoholysis of PU networks, the condition used in this study was much milder, likely due to the use of DMAP catalyst and different molecular structures of PU networks.

In summary, it was demonstrated that property recovery and thermal stability of reprocessable PU networks can be improved by incorporating excess free hydroxyl groups and/or replacing trifunctional cross-linker with tetrafunctional cross-linker. A Tetraol-20OH PU network was developed with full recovery of cross-link density and tensile properties after multiple reprocessing cycles, which has not been reported before. When DMAP catalyst was replaced by DBTDL, the resulting PU network showed poor property recovery after reprocessing, indicating the important role of catalyst selection in preparing dynamic PU networks with excellent reprocessability. A proof-of-principle demonstration that alcohol monomers in PU networks can be recovered by alcoholysis under mild conditions was also provided.

### Experimental Details

### Materials

Tolylene 2,4-diisocyanate terminated polypropylene glycol) (PPG Diisocyanate, average Mₙ˜2,300, narrow molecular weight distribution, isocyanate group ˜3.6 wt %), trimethylolpropane (Triol, ≥98.0%), pentaerythritol (Tetraol, 99%), 4-(dimethylamino)pyridine (DMAP, ReagentPlus®, ≥99%), dibutyltin dilaurate (DBTDL, ≥96.0%), ethylene glycol (anhydrous, 99.8%), N,N-dimethylformamide (DMF, anhydrous, 99.8%), tetrahydrofuran (THF, anhydrous, 99.9%), and dichloromethane (DCM, anhydrous, 99.8%) were from Sigma-Aldrich. All chemicals were used without further purification. PPG Diisocyanate, DBTDL and DMF were dried on molecular sieves before use.

### Synthesis of Polyurethane (PU) Networks

In a typical synthesis of Tetraol-20OH network, 250 mg Tetraol and 149.6 mg DMAP were added to a 20-mL scintillation vial with the total mass of vial+cap recorded prior to weighing. Then 5 mL DMF was added into the vial, and the mixture was heated on a hot plate at 125° C. until complete dissolution to obtain a Tetraol stock solution. The mass of stock solution was determined by subtracting the mass of empty vial from the total mass of solution and vial. The proper amount of stock solution (containing 230.9 mg Tetraol and 138.1 mg DMAP) was then weighed in a Max20 cup (Flacktek) containing 6.5 g PPG Diisocyanate. The concentration of isocyanate groups was adjusted to 1 M by adding another 1.03 mL DMF into the cup, assuming the density of stock solution is 1 g/mL. The reactant mixture was then homogenized in a speed mixer (Flacktek DAC 150.1 FVZ-K) at 3200 rmp for 1 min. Afterward, the reactant mixture was poured into an aluminum pan (96 mm diameter) and cured on a hot plate at 60° C. After gelation (typically within minutes), the sample was transferred to an oven at 80° C. for overnight reaction and then dried for 48 h at 80° C. under vacuum. For details on the formulation of other PU networks, refer to Table 3.

TABLE 3
Formulations for the synthesis of PU networks.

| | PPG | | | | | |
|---|---|---|---|---|---|---|
| | Diiso- | | | | | |
| | cyanate | Triol | Tetraol | DMAP | DBTDL | DMF |
| Sample | (g) | (mg) | (mg) | (mg) | (mg) | (mL) |
| Triol-0OH | 6.5 | 252.8 | 0 | 138.1 | 0 | 5.65 |
| Triol-20OH | 6.5 | 303.3 | 0 | 138.1 | 0 | 5.65 |
| Tetraol-0OH | 6.5 | 0 | 192.4 | 138.1 | 0 | 5.65 |
| Tetraol-20OH | 6.5 | 0 | 230.9 | 138.1 | 0 | 5.65 |
| Tetraol-20OH-Tin | 6.5 | 0 | 230.9 | 0 | 35.7 | 5.65 |

### Reprocessing Procedure

Reprocessing of PU networks was performed using a PHI hot press. After obtaining DMA or tensile test samples from as-synthesized materials, residual materials were cut into small pieces and then pressed into ˜1 mm thick sheets using a 7-ton ram force, which were considered as 1st molded samples. Similarly, 1st molded materials were then cut into small pieces and pressed again to obtain 2nd molded materials. All PU networks containing DMAP were reprocessed at 140° C. for 70 min. The PU network containing DBTDL was reprocessed at 120° C. for 15 min.

### Alcoholysis of PU Networks

In a 20 mL scintillation vial, ˜300 mg of the as-synthesized Tetraol-20OH network was added, together with 15.4 mg DMAP (0.5 eq with respect to urethane groups in the PU network) and 1 mL ethylene glycol. The mixture was heated on a hot plate at 130° C. for 8 h, during which time the network materials were gradually “dissolved”.

### Characterization

Dynamic mechanical analysis (DMA) was performed with a TA Instruments RSA III. Specifically, storage modulus (E′), loss modulus (E″), and damping ratio tan δ (E″/E′) were recorded as functions of temperature on the heating scan from ˜60 to 60° C. at a 3° C./min heating rate. The measurement was performed in tension mode under a 0.03% oscillatory strain at 1 Hz frequency. For each sample, at least three measurements were performed, and the E′ value at 40° C. was reported as the average rubbery plateau modulus with errors given by standard deviations. The high-temperature DMA measurement was performed on as-synthesized PU samples, in which samples underwent temperature ramps set from −60 to 300° C. The measurement was stopped when the equipment started to report inconsistent results due to the flow of sample. The corresponding temperature was recorded as T_{flow} of the material.

Uniaxial tensile testing was performed with a TA Instruments RSA-G2 at room temperature. Dog-bone-shaped samples were cut from as-synthesized and molded films using a Dewes-Gumb die. Samples underwent a uniaxial extension at a rate of 1 mm/s until break, with the data collected at a 40 pts/s rate. Tensile properties including Young's modulus, tensile strength, and elongation at break were reported as average values of at least five specimens with errors representing the standard deviations.

Attenuated total reflectance-Fourier transform infrared (ATR-FTIR) spectroscopy was performed using a Bruker Tensor 37 FTIR spectrophotometer equipped with a diamond/ZnSe ATR attachment. All samples were scanned at a resolution of 2 cm⁻¹, and 16 scans were collected in the range of 4000-600 cm⁻¹. Spectra were normalized with respect to the aliphatic ether stretching peak at 1100 cm⁻¹.

Swelling tests were carried out for all as-synthesized and molded PU networks to determine the swelling ratio and gel fraction. Samples (˜100 mg) were immersed in 20 mL of DCM in glass vials and were left to swell at room temperature for 72 h. The liquid phase was replaced with fresh DCM every day. After swelling, the liquid phase was decanted, and the residual solvent on sample surface was carefully wiped off using filter paper. Masses of swollen networks were recorded. Samples were then dried at 60° C. under vacuum until no weight change could be measured. For each sample, three specimens were measured. The gel fraction was determined as m_{d}/m₀, and the swelling ratio was calculated as (mₛ-m_{d})/m_{d}, where m₀ is the original mass of the sample before swelling and mₛ and m_{d} are the masses of the swollen sample and dried sample, respectively.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A crosslinked polyurethane network comprising:
the reaction product of a poly(alkylene glycol) diisocyanate monomer and polyol having at least three hydroxyl groups; and
an alcoholysis catalyst; wherein the crosslinked polyurethane network has a free hydroxyl group concentration of at least 4 mol. %.

2. The crosslinked polyurethane network of claim 1, wherein the poly(alkylene glycol) diisocyanate monomer is poly(propylene glycol).

3. The crosslinked polyurethane network of claim 2, wherein the polyol has at least four hydroxyl groups.

4. The crosslinked polyurethane network of claim 3, wherein the polyol is pentaerythritol.

5. The crosslinked polyurethane network of claim 2, wherein the polyol is trimethylolpropane.

6. The crosslinked polyurethane network of claim 2 having a free hydroxyl group concentration of at least 20 mol. %.

7. The crosslinked polyurethane network of claim 2 having a free hydroxyl group concentration in the range from 4 mol. % to 40 mol. %.

8. The crosslinked polyurethane network of claim 2, wherein the alcoholysis catalyst is 4-(dimethylamino)pyridine.

9. The crosslinked polyurethane network of claim 2, wherein the poly(propylene glycol) diisocyanate has the structure: 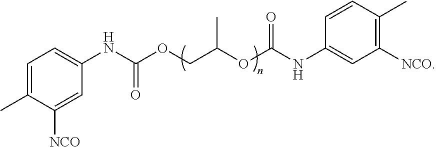
where n is in the range from 1 to 400.

10. The crosslinked polyurethane network of claim 9, wherein the polyol is pentaerythritol and the alcoholysis catalyst is 4-(dimethylamino)pyridine.

11. The crosslinked polyurethane network of claim 2, characterized in that the E′ of the crosslinked polyurethane network, as measured at 40° C., is reduced by less than 5% after the crosslinked polyurethane network is reprocessed at 140° C. for 70 minutes.

12. The crosslinked polyurethane network of claim 2, wherein the crosslinked polyurethane network has a T_{flow} of at least 260° C.

13. A method for recovering monomers from a crosslinked polyurethane network comprising:
the reaction product of a poly(alkylene glycol) diisocyanate monomer and a polyol crosslinker having at least three hydroxyl groups; and
an alcoholysis catalyst; wherein the crosslinked polyurethane network has a free hydroxyl group concentration of at least 4 mol. %;
the method comprising:
heating the crosslinked polyurethane network in the presence of an alcohol solvent to a temperature in the range from 100° C. to 150° C. to depolymerize the poly(alkylene glycol) diisocyanate monomers and polyol crosslinker; and
recovering the poly(propylene glycol) diisocyanate monomers.

14. The method of claim 13, wherein the alcoholysis catalyst is 4-(dimethylamino)pyridine.

15. The method of claim 13, wherein the polyol has at least four hydroxyl groups.

16. The method of claim 15, wherein the polyol is pentaerythritol.

17. The method of claim 13, wherein the polyol is trimethylolpropane.

18. The method of claim 13, wherein the crosslinked polyurethane network has a free hydroxyl group concentration of at least 20 mol. %.

19. A method of forming a reprocessable crosslinked polyurethane network, the method comprising reacting a poly(alkylene glycol) diisocyanate with a multi-functional alcohol crosslinker having at least three hydroxyl groups in the presence of an alcoholysis catalyst to form a crosslinked polyurethane network, wherein the multi-functional alcohol crosslinker is present in sufficiently high excess to provide the crosslinked polyurethane network with a free hydroxyl group concentration of at least 4 mol. %.

20. The method of claim 19, wherein the polyol has at least four hydroxyl groups.
